(19) United States
(12) Patent Application Publication
(10) Pub. No.: US 2024/0302576 A1
(43) Pub. Date: Sep. 12, 2024

(54) SYSTEMS AND METHODS OF ANTI-SMUDGE COATINGS ON LENSES

(71) Applicant: Unsmudgeable, Inc., Mansfield, MA (US)

(72) Inventor: Swarnambika SHIV, Wellesley Hills, MA (US)

(73) Assignee: Unsmudgeable, Inc., Mansfield, MA (US)

(21) Appl. No.: 18/599,507

(22) Filed: Mar. 8, 2024

Related U.S. Application Data
(60) Provisional application No. 63/489,194, filed on Mar. 9, 2023.

(51) Int. Cl. G02B 1/18; G02B 1/11; G02C 7/10; G02B 1/14

(52) U.S. Cl. CPC G02B 1/18; G02B 1/11; G02C 7/10; G02B 1/14

(57) ABSTRACT

Systems and methods of anti-smudge lens coatings are provided herein. The system can include an optically transparent substrate. The optically transparent substrate can include a lens. The system can include a lipophilic coating disposed on the optically transparent substrate. The lipophilic coating can disperse a contaminant disposed on the lipophilic coating such that the contaminant disposed on the lipophilic coating is optically transparent.

### CROSS-REFERENCE TO RELATED APPLICATION

This application claims the benefit of and priority to U.S. Provisional Application No. 63/489,194, filed Mar. 9, 2023, which is hereby incorporated by reference herein in its entirety.

### BACKGROUND

Glasses can include a frame and lenses. The lenses can improve a wearer's ability to see.

### SUMMARY

At least one aspect of the present disclosure is directed to a system. The system can include an optically transparent substrate. The optically transparent substrate can include a lens. The system can include a lipophilic coating disposed on the optically transparent substrate. The lipophilic coating can disperse a contaminant disposed on the lipophilic coating such that the contaminant disposed on the lipophilic coating can be optically transparent.

Another aspect of the present disclosure is directed to a method. The method can include mixing an oil with a diluent to form a mixture. The method can include disposing the mixture on an optically transparent substrate. The method can include curing the mixture to form a lipophilic coating on the optically transparent substrate. The lipophilic coating can disperse a contaminant disposed on the lipophilic coating such that the contaminant disposed on the lipophilic coating can be optically transparent.

The summary is illustrative only and is not intended to be limiting. Other aspects, inventive features, and advantages of the devices or processes described herein, as defined solely by the claims, will become apparent in the detailed description set forth herein and taken in conjunction with the accompanying drawings.

### BRIEF DESCRIPTION OF THE DRAWINGS

The details of one or more implementations of the subject matter described in this specification are set forth in the accompanying drawings and the description below. Other features, aspects, and advantages of the subject matter will become apparent from the description, the drawings, and the claims.

FIG. 1 illustrates an exploded view of a system, according to an example implementation.

FIG. 2 illustrates a perspective view of a system, according to an example implementation.

FIG. 3 illustrates a perspective view of a system, according to an example implementation.

FIG. 4 illustrates a method of producing an anti-smudge coating, according to an example implementation.

FIG. 5 illustrates a method of producing an anti-smudge coating, according to an example implementation.

FIG. 6 illustrates a method of providing a system, according to an example implementation.

FIG. 7 illustrates microscopy images of slides coated with anti-smudge coatings, according to an example implementation.

Like reference numbers and designations in the various drawings indicate like elements.

### DETAILED DESCRIPTION

Following below are more detailed descriptions of various concepts related to, and implementations of, methods, apparatuses, and systems for anti-smudge coatings on lenses. The various concepts introduced above and discussed in greater detail below may be implemented in any of a number of ways, as the described concepts are not limited to any particular manner of implementation. Examples of specific implementations and applications are provided primarily for illustrative purposes.

The present disclosure is directed to systems and methods for anti-smudge coatings on lenses or other transparent surfaces. Eyewear (e.g., glasses, sunglasses, goggles) can include one or more lenses, which can have an oleophobic surface. The lens of the eyewear can become smudged, which can prevent the wearer of the eyewear to see clearly through the lens. For example, the lens can become smudged when the wearer accidentally touches the lens. The smudge on the lens can be made of sebum (e.g., a mixture of sweat and oil from the wearer's finger or face). The oleophobic surface of the lens can cause the oil to cluster on the lens's surface and cause the light to refract in such a way that the wearer is not able to see through the smudge. The eyewear can include prescription eyewear, protective eyewear, or ornamental/fashion eyewear.

Systems and methods of the present technical solution can provide anti-smudge coatings on lenses. The system can include an optically transparent substrate. The optically transparent substrate can include a lens. The system can include a lipophilic coating disposed on the optically transparent substrate. The lipophilic coating can disperse a contaminant disposed on the lipophilic coating such that the contaminant disposed on the lipophilic coating is optically transparent.

The disclosed solutions have a technical advantage of preventing smudges on a lens from obstructing the wearer's visual field. The solutions can include a coating that has a non-toxic formula. For example, the solutions can be free of chemicals (e.g., fluorinated chemicals) that can be harmful to the environment or to the wearer's skin. The coating can be lipophilic to allow the oil to spread rather than cluster. The solutions can reduce eyestrain by reducing visual obstructions on the lenses that prevent the wearer from focusing clearly. The solutions can allow the wearer to have a clear line of vision without having to manually remove one or more smudges on the lens. The solutions can reduce or eliminate the need to clean smudged lenses with a microfiber cloth. The solutions can reduce or eliminate the wearer's need to stop their activity and clean their smudged lenses. The solutions can provide for a permanent way to prevent smudging on lenses of eyewear.

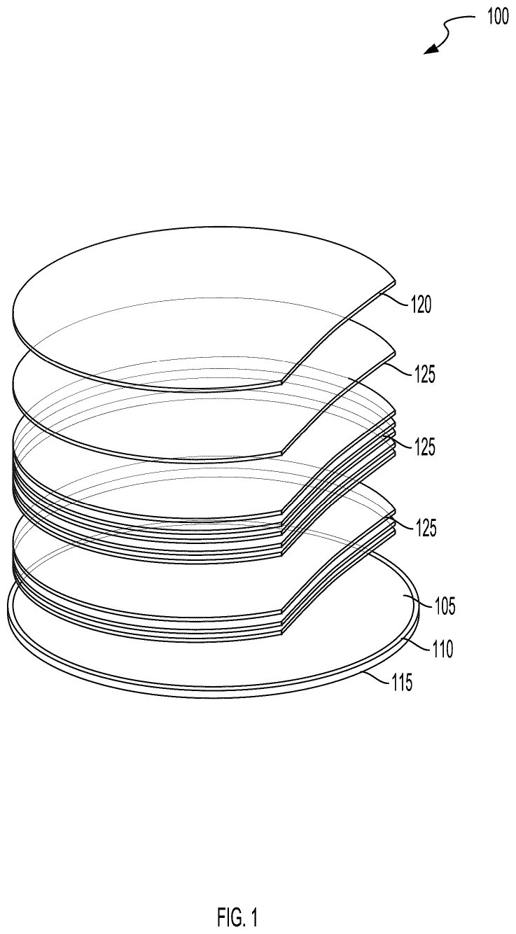

FIG. 1 illustrates an exploded view of a system 100. The system can include one or more optically transparent substrates 105. The optically transparent substrate 105 can include a substrate that allows light to pass through the substrate. The optically transparent substrate 105 can include a substrate that allows light to pass through the material without scattering the light. The optically transparent substrate 105 can include a substrate that allows light to pass through the material without reflecting the light. The optically transparent substrate 105 can have the property of transparency (e.g., allowing light to pass through without scattering light) and/or translucency (e.g., allowing light to pass through but does not necessarily follow Snell's law). The optically transparent substrate 105 can be clear. The optically transparent substrate 105 can allow greater than 80% of the light (e.g., visible light) to pass through the optically transparent substrate 105. For example, the optically transparent substrate 105 can allow greater than 80%, greater than 85%, greater than 90%, greater than 95%, greater than 98%, greater than 99%, greater than 99.5%, greater than 99.9% of the light to pass through the optically transparent substrate 105. The optically transparent substrate 105 can allow substantially all incoming light to pass through the optically transparent substrate 105. The optically transparent substrate 105 may not absorb light. The optically transparent substrate 105 may not diffract light. The optically transparent substrate 105 can include a lens (e.g., glasses lens, eyeglass lens, goggle lens, camera lens, microscope lens, telescope lens, binocular lens, monocle lens, magnifying glass, projector lens, etc.). The optically transparent substrate 105 can include goggles, helmets, or optics equipment. The optically transparent substrate 105 can be a substrate that is not a lens. For example, the optically transparent substrate 105 can include a translucent or transparent substrate that is not a lens. The optically transparent substrate 105 can allow light to pass through the substrate. The lens can focus light. The lens can be optically transparent. The optically transparent substrate 105 can be made of polyethylene, polycarbonate, polymers, glass, plastic, CR-39, Trivex, or a combination thereof. The optically transparent substrate 105 can be disposed in a frame (e.g., eyeglass frame). The optically transparent substrate 105 can include a screen (e.g., phone screen), a window, a mirror, a windshield, or optical equipment.

The optically transparent substrate 105 can include a first side 110 of the optically transparent substrate 105. The first side 110 of the optically transparent substrate 105 can be oriented away or towards a wearer's face. The first side 110 of the optically transparent substrate 105 can be substantially planar. The first side 110 of the optically transparent substrate 105 can be curved. The wearer (e.g., wearer of the system 100) can visualize one or more objects in front of the wearer by looking through the first side 110 of the optically transparent substrate 105.

The optically transparent substrate 105 can include a second side 115 of the optically transparent substrate 105. The second side 115 of the optically transparent substrate 105 can be oriented away or towards a wearer's face. The second side 115 of the optically transparent substrate 105 can be substantially planar. The second side 115 of the optically transparent substrate 105 can be curved. The wearer can visualize one or more objects in front of the wearer by looking through the second side 115 of the optically transparent substrate 105. For example, the wearer can visualize objects by looking through the second side 115 of the optically transparent substrate 105 and then through the first side 110 of the optically transparent substrate 105. The wearer can visualize objects by looking through the first side 110 of the optically transparent substrate 105 and then through the second side 115 of the optically transparent substrate 105. The first side 110 of the optically transparent substrate 105 can be disposed opposite the second side 115 of the optically transparent substrate 105. The second side 115 of the optically transparent substrate 105 can be disposed opposite the first side 110 of the optically transparent substrate 105.

The system 100 can include one or more lipophilic coatings 120 (e.g., anti-smudge coating, anti-smudge lens coating, smudge-resistant coating, oleophilic coating, anti-fingerprint). The lipophilic coating 120 can be disposed (e.g., coated, deposited, layered) on the optically transparent substrate 105. The lipophilic coating 120 can be coated on a surface of the optically transparent substrate 105. The optically transparent substrate 105 can have a lipophilic surface. The lipophilic coating 120 can be uniformly or nonuniformly coated on the optically transparent substrate 105. The lipophilic coating 120 can be coated on a portion of the optically transparent substrate 105. The lipophilic coating 120 can be disposed on the first side 110 of the optically transparent substrate 105. The lipophilic coating 120 can be coated on the first side 110 of the optically transparent substrate 105. The lipophilic coating 120 can be disposed on the second side 115 of the optically transparent substrate 105.

The lipophilic coating 120 can be coated on the second side 115 of the optically transparent substrate 105. The lipophilic coating 120 can be optically transparent. For example, the lipophilic coating 120 can allow light waves to pass through the lipophilic coating 120. The lipophilic coating 120 can allow visible light to pass through the lipophilic coating 120. The lipophilic coating 120 can be exposed to air. The lipophilic coating 120 can reduce the surface tension of the lens material. The lipophilic coating 120 can allow oils (e.g., oils from skin and fingers) to spread into an ultra-thin film rather than forming disruptive droplets. The lipophilic coating 120 can include a mix of biomaterial polymers. The lipophilic coating 120 can differ from coatings that cause beading up of oils, which can refract light and impair vision.

The lipophilic coating 120 can form a lipophilic layer on the optically transparent substrate 105. For example, the lipophilic coating 120 can form a lipophilic layer on the first side 110 of the optically transparent substrate 105. The lipophilic coating 120 can form a lipophilic layer on the second side 115 of the optically transparent substrate 105. The lipophilic coating 120 can form an oleophilic layer on the optically transparent substrate 105. The lipophilic coating 120 can include a fingerprint-dissipating coating. The lipophilic coating 120 can include a fingerprint-hiding coating. The lipophilic coating 120 can include a fingerprint-fading coating. The lipophilic coating 120 can remove visual traces of fingerprints. The lipophilic coating 120 can include an anti-fingerprint coating.

The lipophilic coating 120 can include one or more oils. The oil can include a bio-oil or a drying oil (e.g., photosensitive drying oil). The oil can harden to a solid film after exposure to air. The oil can form a lipophilic layer on the surface of the lens. The lipophilic coating 120 can include at least one of flaxseed oil, lemon oil, walnut oil, olive oil, sesame oil, grapefruit oil, or a combination thereof. The oil can be a high purity oil. For example, the oil can be 95% pure, 99% pure, 99.9% pure, or 100% pure. The high purity oil can prevent discoloration of the lipophilic coating 120. The lipophilic coating 120 can be free of perfluorinated and/or polyfluorinated substances (PFAS). The lipophilic coating 120 can include a PFAS-free coating. The lipophilic coating 120 can include a PFAS-free permanent anti-smudge lens coating. The lipophilic coating 120 can provide a clear line of vision through the lens. The lipophilic coating 120 can be free of fluorochemicals. The lipophilic coating 120 can be free of fluorosilane. The lipophilic coating 120 can be hydrophobic.

The lipophilic coating 120 can have a thickness in a range of 5 nm to 150 μm. For example, the lipophilic coating 120 can have a thickness in a range of 5 nm to 50 nm, 5 nm to 100 nm, 5 nm to 1 μm, 5 nm to 10 μm, 5 nm to 50 μm, 5 nm to 100 μm, 5 nm to 150 μm, 50 nm to 100 nm, 50 nm to 1 μm, 50 nm to 10 μm, 50 nm to 50 μm, 50 nm to 100 μm, 50 nm to 150 μm, 100 nm to 1 μm, 100 nm to 10 μm, 100 nm to 50 μm, 100 nm to 100 μm, 100 nm to 150 μm, 1 μm to 10 μm, 1 μm to 50 μm, 1 μm to 100 μm, 1 μm to 150 μm, 10 μm to 50 μm, 10 μm to 100 μm, 10 μm to 150 μm, 50 μm to 100 μm, 50 μm to 150 μm, or 100 μm to 150 μm.

The lipophilic coating 120 can be a liquid at room temperature. The lipophilic coating 120 can be stored at a temperature in a range of 5° C. to 60° C. For example, the lipophilic coating 120 can be stored at a temperature in a range of 5° C. to 10° C., 5° C. to 15° C., 5° C. to 20° C., 5° C. to 25° C., 5° C. to 30° C., 5° C. to 35° C., 5° C. to 40° C., 5° C. to 45° C., 5° C. to 50° C., 5° C. to 55° C., 5° C. to 60° C., 10° C. to 15° C., 10° C. to 20° C., 10° C. to 25° C., 10° C. to 30° C., 10° C. to 35° C., 10° C. to 40° C., 10° C. to 45° C., 10° C. to 50° C., 10° C. to 55° C., 10° C. to 60° C., 15° C. to 20° C., 15° C. to 25° C., 15° C. to 30° C., 15° C. to 35° C., 15° C. to 40° C., 15° C. to 45° C., 15° C. to 50° C., 15° C. to 55° C., 15° C. to 60° C., 20° C. to 25° C., 20° C. to 30° C., 20° C. to 35° C., 20° C. to 40° C., 20° C. to 45° C., 20° C. to 50° C., 20° C. to 55° C., 20° C. to 60° C., 25° C. to 30° C., 25° C. to 35° C., 25° C. to 40° C., 25° C. to 45° C., 25° C. to 50° C., 25° C. to 55° C., 25° C. to 60° C., 30° C. to 35° C., 30° C. to 40° C., 30° C. to 45° C., 30° C. to 50° C., 30° C. to 55° C., 30° C. to 60° C., 35° C. to 40° C., 35° C. to 45° C., 35° C. to 50° C., 35° C. to 55° C., 35° C. to 60° C., 40° C. to 45° C., 40° C. to 50° C., 40° C. to 55° C., 40° C. to 60° C., 45° C. to 50° C., 45° C. to 55° C., 45° C. to 60° C., 50° C. to 55° C., 50° C. to 60° C., or 55° C. to 60° C.

The lipophilic coating 120 can have a water contact angle in a range of 91° to 100°. For example, the lipophilic coating 120 can have a water contact angle in a range of 91° to 92°, 91° to 93°, 91° to 94°, 91° to 95°, 91° to 96°, 91° to 97°, 91° to 98°, 91° to 99°, 91° to 100°, 92° to 93°, 92° to 94°, 92° to 95°, 92° to 96°, 92° to 97°, 92° to 98°, 92° to 99°, 92° to 100°, 93° to 94°, 93° to 95°, 93° to 96°, 93° to 97°, 93° to 98°, 93° to 99°, 93° to 100°, 94° to 95°, 94° to 96°, 94° to 97°, 94° to 98°, 94° to 99°, 94° to 100°, 95° to 96°, 95° to 97°, 95° to 98°, 95° to 99°, 95° to 100°, 96° to 97°, 96° to 98°, 96° to 99°, 96° to 100°, 97° to 98°, 97° to 99°, 97° to 100°, 98° to 99°, 98° to 100°, or 99° to 100°.

The lipophilic coating 120 can have a transparency on borosilicate glass in a range of 85% to 95%. For example, the lipophilic coating 120 can have a transparency on borosilicate glass in a range of 85% to 87%, 85% to 89%, 85% to 91%, 85% to 93%, 85% to 95%, 87% to 89%, 87% to 91%, 87% to 93%, 87% to 95%, 89% to 91%, 89% to 93%, 89% to 95%, 91% to 93%, 91% to 95%, or 93% to 95%.

The lipophilic coating 120 can have a refractive index. The refractive index of the lipophilic coating 120 can be the same as the refractive index of the optically transparent substrate 105. For example, the refractive index of the lipophilic coating 120 can be the same as the refractive index of the lens. The refractive index of the lipophilic coating 120 can be the same as the refractive index of polycarbonate. The refractive index of the lipophilic coating 120 can be the same as the refractive index of glass.

The lipophilic coating 120 can include a bio-oil or a drying oil. The lipophilic coating 120 can include polydimethylsiloxane. The polydimethylsiloxane can increase the molecular weight of the lipophilic coating 120. The lipophilic oil can be water-repellent. The silicone oil can improve water repellency. The lipophilic coating 120 can include silica nanoparticles. The silica nanoparticles can increase the molecular weight of the lipophilic coating 120. The lipophilic coating 120 can include an alkyd. The alkyd can reduce the curing time.

The system 100 can include one or more additional coatings 125. The one or more additional coatings 125 can include at least one of an anti-reflective coating, an ultraviolet (UV) coating, a scratch-resistant coating, a mirror coating, a blue light filtration coating, and a waterproof coating. The one or more additional coating 125 can be disposed on the first side 110 of the optically transparent substrate 105 or the second side 115 of the optically transparent substrate 105. The one or more additional coating 125 can be disposed between the first side 110 of the optically transparent substrate 105 and the lipophilic coating 120. For example, the lipophilic coating 120 can be disposed on the one or more additional coatings 125, and the one or more additional coatings 125 can be disposed on the first side 110 of the optically transparent substrate 105. The one or more additional coating 125 can be disposed between the second side 115 of the optically transparent substrate 105 and the lipophilic coating 120. For example, the lipophilic coating 120 can be disposed on the one or more additional coatings 125, and the one or more additional coatings 125 can be disposed on the second side 115 of the optically transparent substrate 105. The anti-reflective coating can be disposed on the optically transparent substrate 105. The lipophilic coating 120 can be disposed on the anti-reflective coating.

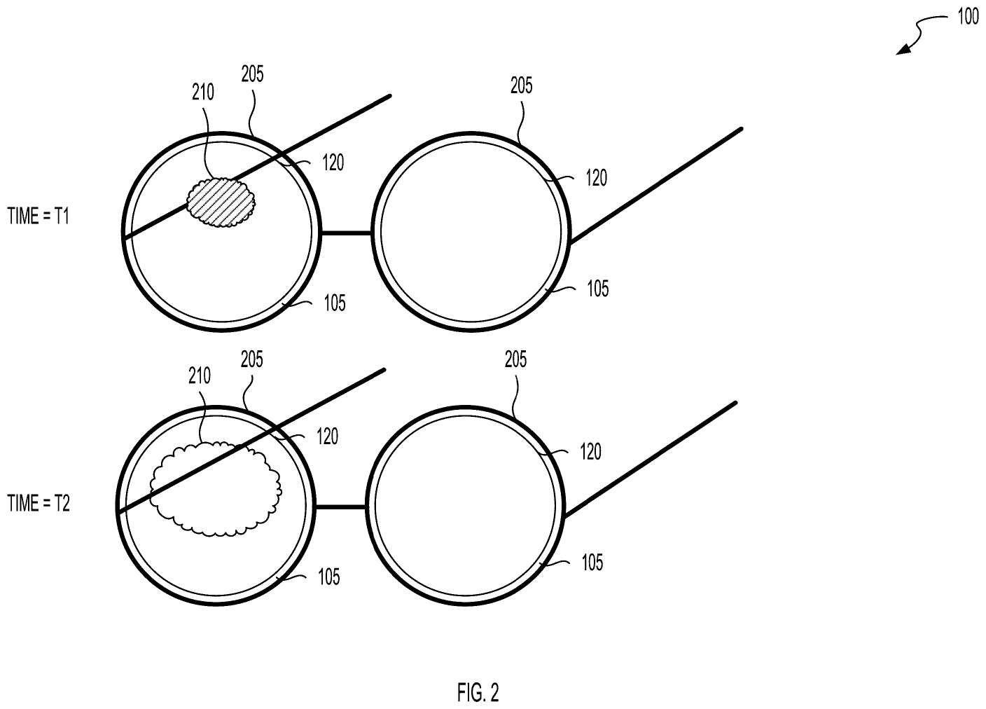

FIG. 2 illustrates a perspective view of the system 100. The system 100 can include the optically transparent substrate 105. The system 100 can include the lipophilic coating 120. The system 100 can include a frame 205 (e.g., eyeglass frame, ophthalmic frame). The optically transparent substrate 105 can be disposed in the frame 205. The frame 205 can be coupled with the optically transparent substrate 105. The optically transparent substrate 105 can be disposed in the ophthalmic frame.

The system 100 can include one or more contaminants 210 (e.g., impurities). The contaminant 210 can include sebum (e.g., a mixture of sweat and oil). The contaminant can have a tint. The contaminant 210 can be disposed on the optically transparent substrate 105 at time=T₁. At time=T₁, the contaminant 210 can be opaque. The contaminant 210 can be non-optically transparent. The contaminant 210 can include a smudge. For example, the contaminant 210 can include a smudge that does not allow the wearer to see clearly through the lens. The smudge can include a fingerprint. The smudge can include facial oils. The smudge can include sebum. The smudge can include residue of sebum from skin. The contaminant 210 can obstruct the wearer's visual field. The contaminant 210 can prevent the wearer from clearly seeing object in front of the wearer. The contaminant 210 at time=T₁ can have a first thickness.

At time=T₂, the contaminant 210 can be optically transparent. T₂ can be greater than T₁. The lipophilic coating 120 can disperse the contaminant 210. The lipophilic coating 120 can disperse the contaminant 210 on the lipophilic coating 120 such that the contaminant 210 disposed on the lipophilic coating 120 is optically transparent. Optical transparency can include optical transparency of one or more wavelengths of light. The lipophilic coating 120 can disperse the contaminant 210 on the lipophilic coating 120 such that the contaminant 210 disposed on the lipophilic coating 120 allows light to pass through the contaminant 210 and the lipophilic coating 120. The light can have one or more wavelengths. The lipophilic coating 120 can disperse the contaminant 210 on the lipophilic coating 120 such that the contaminant 210 disposed on the lipophilic coating 120 does not scatter light. The lipophilic coating 120 can disperse the contaminant 210 on the lipophilic coating 120 such that the contaminant 210 disposed on the lipophilic coating 120 scatters certain wavelengths of light. The lipophilic coating 120 can cause the contaminant 210 to become optically transparent. The lipophilic coating 120 can cause the contaminant 210 to spread on the surface of the lipophilic coating 120. The lipophilic coating 120 can disperse the contaminant 210 between time=T₁ and time=T₂. The contaminant 210 at time=T₂ can have a second thickness.

The lipophilic coating 120 can reduce a thickness of the contaminant 210 by 30% to 95%. For example, the lipophilic coating 120 can reduce a thickness of the contaminant 210 by 30%, 35%, 40%, 45%, 50%, 55%, 60%, 65%, 70%, 75%, 80%, 85%, 90%, or 95%. The lipophilic coating 120 can cause the contaminant 210 to decrease its thickness from time=T₁ to time=T₂. The second thickness can be less than the first thickness. For example, the second thickness can be 70% of the first thickness, 65% of the first thickness, 60% of the first thickness, 55% of the first thickness, 50% of the first thickness, 45% of the first thickness, 40% of the first thickness, 35% of the first thickness, 30% of the first thickness, 25% of the first thickness, 20% of the first thickness, 15% of the first thickness, 10% of the first thickness, or 5% of the first thickness.

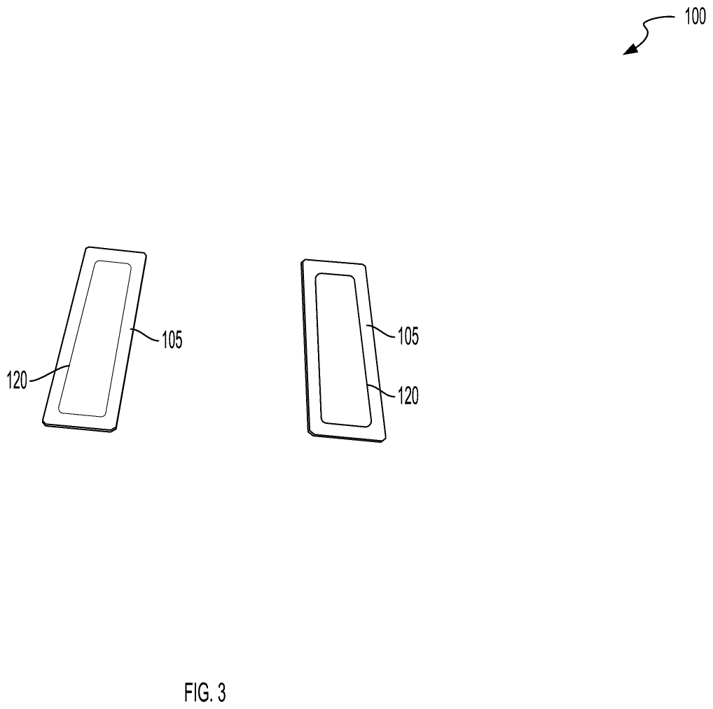

FIG. 3 illustrates a perspective view of the system 100. The system 100 can include the optically transparent substrate 105. The optically transparent substrate 105 can include a glass slide. The system 100 can include the lipophilic coating 120. The lipophilic coating 120 can be disposed on the glass slide.

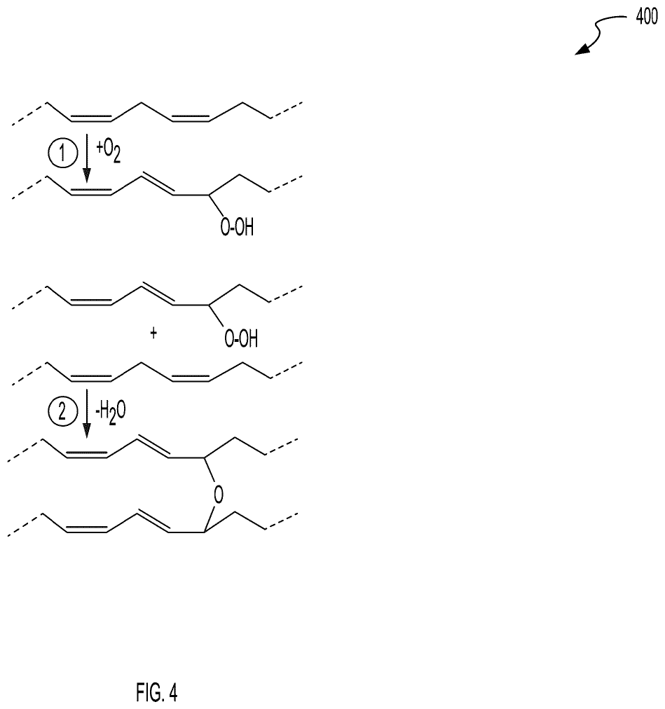

FIG. 4 illustrates a method 400 of producing an anti-smudge coating. The method 400 can include drying (e.g., hardening, curing) the lipophilic coating 120. The method 400 can include autoxidation of an organic compound and subsequent crosslinking. In the first step, the diene can undergo autoxidation to give a hydroperoxide. In the second step, the hydroperoxide can combine with another unsaturated side chain to generate a crosslink. The hydroperoxide can include an organic compound. For example, the hydroperoxide can include an organic compound that forms after curing.

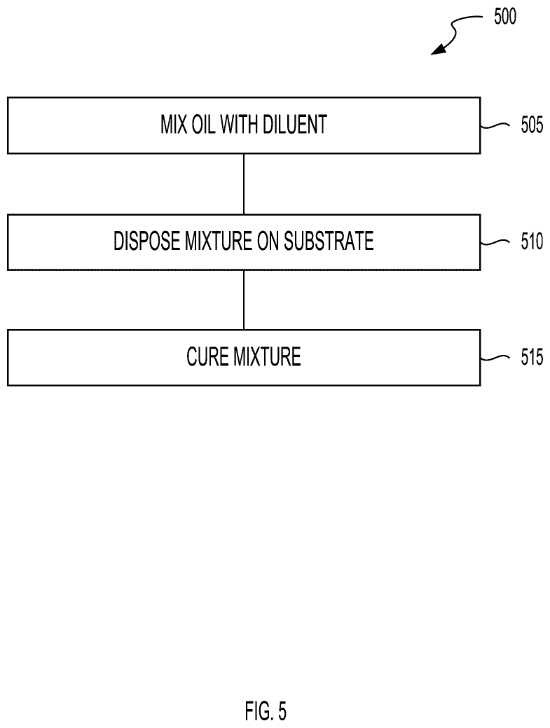

FIG. 5 illustrates a method 500 of producing the anti-smudge coating. The method 500 can include mixing an oil with a diluent (ACT 505). The method 500 can include disposing the mixture on a substrate (ACT 510). The method 500 can include curing the mixture (ACT 515).

The method 500 can include mixing an oil with a diluent (ACT 505). For example, the method 400 can include mixing the oil with the diluent to form a mixture. The oil can include at least one of flaxseed oil, lemon oil, walnut oil, olive oil, sesame oil, grapefruit oil, or a combination thereof. The oil can be a high purity oil. For example, the oil can be 95% pure, 99% pure, 99.9% pure, or 100% pure. The high purity oil can prevent discoloration of the lipophilic coating 120. The diluent can include at least one of isopropyl alcohol, paint thinner, processed vegetable oil, or a combination thereof. The diluent can include a vegetable-based diluent. The diluent can include a solvent. The method 500 can include forming a mixture with oil in a range of 80 wt % to 90 wt % and diluent in range of 10 wt % to 20 wt %. For example, the mixture can include 80 wt % oil and 20 wt % diluent, 85 wt % oil and 15 wt % diluent, or 90 wt % oil and 10 wt % diluent. The mixture can be formed in a reduced oxygen environment (e.g., less than 21% O₂, less than 10% O₂, less than 5% O₂, less than 1% O₂).

The method 500 can include disposing the mixture on a substrate (ACT 510). For example, the method 500 can include disposing the mixture on the optically transparent substrate 105. Disposing the mixture on the substrate can include spraying the mixture on the optically transparent substrate 105. For example, the mixture can be sprayed as an even coating onto the optically transparent substrate 105. The mixture can be sprayed onto the optically transparent substrate 105 using an atomizer (e.g., atomizer bottle). The mixture can be spin-coated, dip-coated, or spray-coated. For example, the mixture can be spin-coated, dip-coated, or spray-coated onto the optically transparent substrate 105. The method 500 can include disposing the mixture on the first side 110 of the optically transparent substrate 105. The method 500 can include disposing the mixture on the second side 115 of the optically transparent substrate 105. The second side 115 of the optically transparent substrate 105 can be disposed opposite the first side 110 of the optically transparent substrate 105.

The method 500 can include curing the mixture (ACT 515). The method 500 can include curing the mixture to form the lipophilic coating 120 on the optically transparent substrate 105. The lipophilic coating 120 can disperse the contaminant 210 disposed on the lipophilic coating 120 such that the contaminant 210 disposed on the lipophilic coating 120 is optically transparent. The method 500 can include curing the mixture with ultraviolet light. For example, the method 500 can include UV curing the mixture. Curing the mixture can be accelerated using a biocompatible photoinitiator. The lipophilic coating 120 can be UV-cured. For example, the lipophilic coating 120 can be UV-cured using a biocompatible photoinitiator. The mixture can be cured in a reduced oxygen environment.

The method 500 can include curing the mixture for a time in a range of 15 minutes to 48 hours. For example, the method 500 can include curing the mixture for a time in a range of 15 minutes to 30 minutes, 15 minutes to 1 hour, 15 minutes to 2 hours, 15 minutes to 4 hours, 15 minutes to 8 hours, 15 minutes to 16 hours, 15 minutes to 24 hours, 15 minutes to 48 hours, 30 minutes to 1 hour, 30 minutes to 2 hours, 30 minutes to 4 hours, 30 minutes to 8 hours, 30 minutes to 16 hours, 30 minutes to 24 hours, 30 minutes to 48 hours, 1 hour to 2 hours, 1 hour to 4 hours, 1 hour to 8 hours, 1 hour to 16 hours, 1 hour to 24 hours, 1 hour to 48 hours, 2 hours to 4 hours, 2 hours to 8 hours, 2 hours to 16 hours, 2 hours to 24 hours, 2 hours to 48 hours, 4 hours to 8 hours, 4 hours to 16 hours, 4 hours to 24 hours, 4 hours to 48 hours, 8 hours to 16 hours, 8 hours to 24 hours, 8 hours to 48 hours, 16 hours to 24 hours, 16 hours to 48 hours, or 24 hours to 48 hours.

The method 500 can include curing the mixture at a temperature in a range of 15° C. to 200° C. For example, the method 500 can include curing the mixture at a temperature in a range of 15° C. to 20° C., 15° C. to 25° C., 15° C. to 50° C., 15° C. to 80° C., 15° C. to 100° C., 15° C. to 120° C., 15° C. to 140° C., 15° C. to 160° C., 15° C. to 180° C., 15° C. to 200° C., 20° C. to 25° C., 20° C. to 50° C., 20° C. to 80° C., 20° C. to 100° C., 20° C. to 120° C., 20° C. to 140° C., 20° C. to 160° C., 20° C. to 180° C., 20° C. to 200° C., 25° C. to 50° C., 25° C. to 80° C., 25° C. to 100° C., 25° C. to 120° C., 25° C. to 140° C., 25° C. to 160° C., 25° C. to 180° C., 25° C. to 200° C., 50° C. to 80° C., 50° C. to 100° C., 50° C. to 120° C., 50° C. to 140° C., 50° C. to 160° C., 50° C. to 180° C., 50° C. to 200° C., 80° C. to 100° C., 80° C. to 120° C., 80° C. to 140° C., 80° C. to 160° C., 80° C. to 180° C., 80° C. to 200° C., 100° C. to 120° C., 100° C. to 140° C., 100° C. to 160° C., 100° C. to 180° C., 100° C. to 200° C., 120° C. to 140° C., 120° C. to 160° C., 120° C. to 180° C., 120° C. to 200° C., 140° C. to 160° C., 140° C. to 180° C., 140° C. to 200° C., 160° C. to 180° C., 160° C. to 200° C., or 180° C. to 200° C. The method 500 can include curing the mixture in an oven with forced heat convection. The method 500 can include curing the mixture for 12 hours at room temperature. The method 500 can include thermally curing the mixture. The method 500 can include UV-curing the mixture. The method 500 can include UV-curing the mixture for a time in a range of 15 minutes to 2 hours. For example, the method 500 can include UV-curing the mixture for a time in a range of 15 minutes to 30 minutes, 15 minutes to 1 hour, 15 minutes to 2 hours, 30 minutes to 1 hour, 30 minutes to 2 hours, or 1 hour to 2 hours.

The method 500 can include curing the mixture at a first temperature for a first time. The first temperature can be in a range of 15° C. to 200° C. For example, the method 500 can include curing the mixture at a temperature in a range of 15° C. to 20° C., 15° C. to 25° C., 15° C. to 50° C., 15° C. to 80° C., 15° C. to 100° C., 15° C. to 120° C., 15° C. to 140° C., 15° C. to 160° C., 15° C. to 180° C., 15° C. to 200° C., 20° C. to 25° C., 20° C. to 50° C., 20° C. to 80° C., 20° C. to 100° C., 20° C. to 120° C., 20° C. to 140° C., 20° C. to 160° C., 20° C. to 180° C., 20° C. to 200° C., 25° C. to 50° C., 25° C. to 80° C., 25° C. to 100° C., 25° C. to 120° C., 25° C. to 140° C., 25° C. to 160° C., 25° C. to 180° C., 25° C. to 200° C., 50° C. to 80° C., 50° C. to 100° C., 50° C. to 120° C., 50° C. to 140° C., 50° C. to 160° C., 50° C. to 180° C., 50° C. to 200° C., 80° C. to 100° C., 80° C. to 120° C., 80° C. to 140° C., 80° C. to 160° C., 80° C. to 180° C., 80° C. to 200° C., 100° C. to 120° C., 100° C. to 140° C., 100° C. to 160° C., 100° C. to 180° C., 100° C. to 200° C., 120° C. to 140° C., 120° C. to 160° C., 120° C. to 180° C., 120° C. to 200° C., 140° C. to 160° C., 140° C. to 180° C., 140° C. to 200° C., 160° C. to 180° C., 160° C. to 200° C., or 180° C. to 200° C. . . . The first time can be in a range of 15 minutes to 30 minutes, 15 minutes to 1 hour, 15 minutes to 2 hours, 15 minutes to 4 hours, 30 minutes to 1 hour, 30 minutes to 2 hours, 30 minutes to 4 hours, 1 hour to 2 hours, 1 hour to 4 hours, or 2 hours to 4 hours.

The method 500 can include curing the mixture at a second temperature for a second time. The second temperature can be in a range of 15° C. to 200° C. For example, the method 500 can include curing the mixture at a temperature in a range of 15° C. to 20° C., 15° C. to 25° C., 15° C. to 50° C., 15° C. to 80° C., 15° C. to 100° C., 15° C. to 120° C., 15° C. to 140° C., 15° C. to 160° C., 15° C. to 180° C., 15° C. to 200° C., 20° C. to 25° C., 20° C. to 50° C., 20° C. to 80° C., 20° C. to 100° C., 20° C. to 120° C., 20° C. to 140° C., 20° C. to 160° C., 20° C. to 180° C., 20° C. to 200° C., 25° C. to 50° C., 25° C. to 80° C., 25° C. to 100° C., 25° C. to 120° C., 25° C. to 140° C., 25° C. to 160° C., 25° C. to 180° C., 25° C. to 200° C., 50° C. to 80° C., 50° C. to 100° C., 50° C. to 120° C., 50° C. to 140° C., 50° C. to 160° C., 50° C. to 180° C., 50° C. to 200° C., 80° C. to 100° C., 80° C. to 120° C., 80° C. to 140° C., 80° C. to 160° C., 80° C. to 180° C., 80° C. to 200° C., 100° C. to 120° C., 100° C. to 140° C., 100° C. to 160° C., 100° C. to 180° C., 100° C. to 200° C., 120° C. to 140° C., 120° C. to 160° C., 120° C. to 180° C., 120° C. to 200° C., 140° C. to 160° C., 140° C. to 180° C., 140° C. to 200° C., 160° C. to 180° C., 160° C. to 200° C., or 180° C. to 200° C. The second time can be in a range of 15 minutes to 30 minutes, 15 minutes to 1 hour, 15 minutes to 2 hours, 15 minutes to 4 hours, 30 minutes to 1 hour, 30 minutes to 2 hours, 30 minutes to 4 hours, 1 hour to 2 hours, 1 hour to 4 hours, or 2 hours to 4 hours. The second time can be subsequent to the first time.

The method 500 can include curing the mixture at the first temperature for the first time. The method 500 can include curing the mixture at the second temperature for the second time. For example, the method 500 can include curing the mixture at 80° C. for 1 hour and then at 100° C. for 1 hour. The method 500 can include UV-curing the mixture and then thermally curing the mixture. The method 500 can include UV-curing the mixture for a range of 15 minutes to two hours. For example, the method 500 can include UV-curing the mixture for a range of 15 minutes to 30 minutes, 15 minutes to 1 hour, 15 minutes to 2 hours, 30 minutes to 1 hour, 30 minutes to 2 hours, or 1 hour to 2 hours. The method 500 can include thermally curing the mixture in a range of 100° C. to 200° C. for 1 hour after UV-curing the mixture. For example, the method 500 can include thermally curing the mixture at 100° C., 120° C., 140° C., 160° C., 180° C., or 200° C. for 1 hour after UV-curing the mixture. The method can include curing flaxseed oil, lemon oil, walnut oil, olive oil, sesame oil, grapefruit oil, or a combination thereof at 80° C. for 1 hour and then at 100° C. for 1 hour. The method 500 can include curing the mixture for 30 minutes, 65 minutes, or 75 minutes.

The method 500 can include disposing the optically transparent substrate 105 in an ophthalmic frame. The method 500 can include disposing the anti-reflective coating on the optically transparent substrate 105. The method 500 can include disposing the lipophilic coating 120 on the anti-reflective coating.

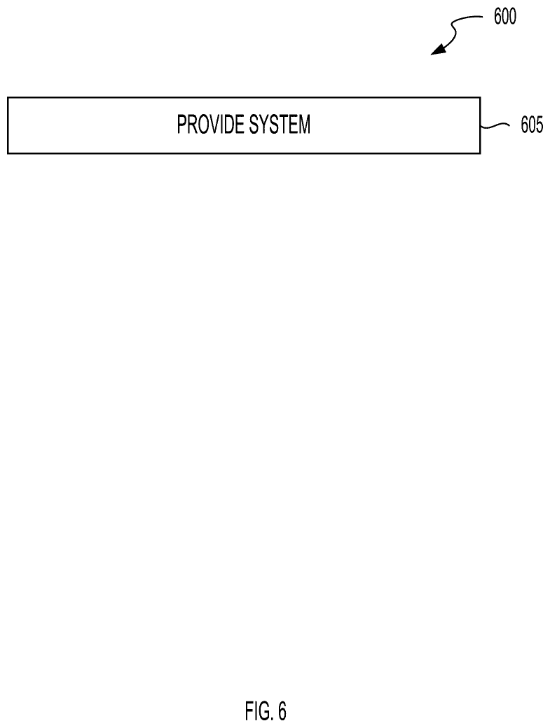

FIG. 6 illustrates a method 600 of providing the system 100. The method 600 can include providing the system 100 (ACT 605). The system 100 can include the optically transparent substrate 105. The optically transparent substrate 105 can include a lens. The system 100 can include the lipophilic coating 120. The lipophilic coating 120 can disperse the contaminant 210 disposed on the lipophilic coating 120 such that the contaminant 210 disposed on the lipophilic coating 120 is optically transparent.

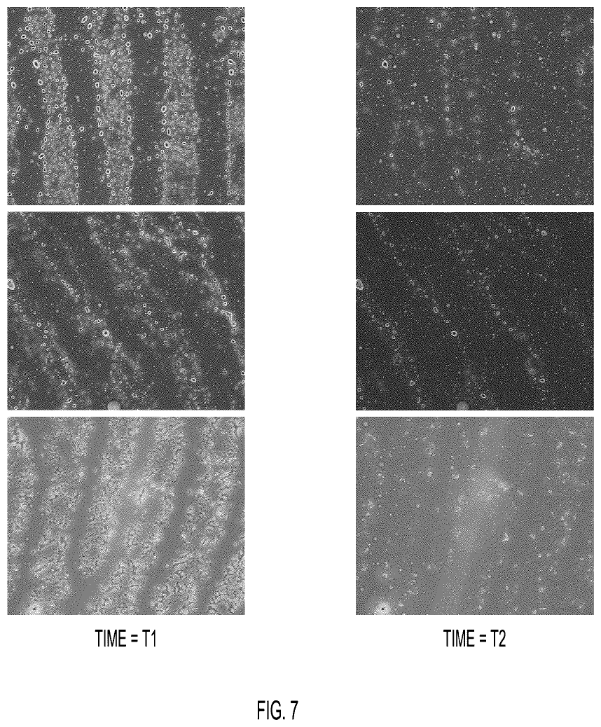

FIG. 7 illustrates microscopy images of slides coated with anti-smudge coatings. The slides can be coated with the lipophilic coating 120. A fingerprint is applied to each of the slides labeled “time=T₁.”. The fingerprint can interact with the lipophilic coating 120. After a period of time, the fingerprint can fade due to its interaction with the lipophilic coating 120. The slides labeled “time=T₂” show the slides after the period of time. The lipophilic coating 120 can improve the visibility through the fingerprint by 140% compared with an uncoated substrate (e.g., lens, slide).

While operations are depicted in the drawings in a particular order, such operations are not required to be performed in the particular order shown or in sequential order, and all illustrated operations are not required to be performed. Actions described herein can be performed in a different order.

Having now described some illustrative implementations, it is apparent that the foregoing is illustrative and not limiting, having been presented by way of example. In particular, although many of the examples presented herein involve specific combinations of method acts or system elements, those acts and those elements may be combined in other ways to accomplish the same objectives. Acts, elements and features discussed in connection with one implementation are not intended to be excluded from a similar role in other implementations or implementations.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular may also embrace implementations including a plurality of these elements, and any references in plural to any implementation or element or act herein may also embrace implementations including only a single element. References in the singular or plural form are not intended to limit the presently disclosed systems or methods, their components, acts, or elements to single or plural configurations. References to any act or element being based on any information, act or element may include implementations where the act or element is based at least in part on any information, act, or element.

Any implementation disclosed herein may be combined with any other implementation or embodiment, and references to “an implementation,” “some implementations,” “one implementation” or the like are not necessarily mutually exclusive and are intended to indicate that a particular feature, structure, or characteristic described in connection with the implementation may be included in at least one implementation or embodiment. Such terms as used herein are not necessarily all referring to the same implementation. Any implementation may be combined with any other implementation, inclusively or exclusively, in any manner consistent with the aspects and implementations disclosed herein.

References to “or” may be construed as inclusive so that any terms described using “or” may indicate any of a single, more than one, and all of the described terms. References to at least one of a conjunctive list of terms may be construed as an inclusive OR to indicate any of a single, more than one, and all of the described terms. For example, a reference to “at least one of ‘A’ and ‘B’” can include only ‘A’, only ‘B’, as well as both ‘A’ and ‘B’. Such references used in conjunction with “comprising” or other open terminology can include additional items.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Modifications of described elements and acts such as variations in sizes, dimensions, structures, shapes and proportions of the various elements, values of parameters, mounting arrangements, use of materials, colors, orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes and omissions can also be made in the design, operating conditions and arrangement of the disclosed elements and operations without departing from the scope of the present disclosure.

Relative parallel, perpendicular, vertical or other positioning or orientation descriptions include variations within +/−10% or +/−10 degrees of pure vertical, parallel or perpendicular positioning. References to “approximately,” “substantially” or other terms of degree include variations of +/−10% from the given measurement, unit, or range unless explicitly indicated otherwise. Coupled elements can be electrically, mechanically, or physically coupled with one another directly or with intervening elements. Scope of the systems and methods described herein is thus indicated by the appended claims, rather than the foregoing description, and changes that come within the meaning and range of equivalency of the claims are embraced therein.

The systems and methods described herein may be embodied in other specific forms without departing from the characteristics thereof. The foregoing implementations are illustrative rather than limiting of the described systems and methods. For example, the lenses, systems, and methods described herein are not limited to eyewear, and can include or be applied to transparent surfaces such as windows, windshields, screens (e.g., windscreens, phone screens), goggles, helmets, camera lenses, optics equipment, glass, plastic, and lights or light fixtures for example.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

What is claimed is:

1. A system, comprising:
an optically transparent substrate including a lens; and
a lipophilic coating disposed on the optically transparent substrate, the lipophilic coating configured to disperse a contaminant disposed on the lipophilic coating such that the contaminant disposed on the lipophilic coating is optically transparent.

2. The system of claim 1, comprising:
the optically transparent substrate comprising a first side of the optically transparent substrate; and
the lipophilic coating disposed on the first side of the optically transparent substrate.

3. The system of claim 1, comprising:
the optically transparent substrate comprising a first side of the optically transparent substrate and a second side of the optically transparent substrate disposed opposite the first side of the optically transparent substrate; and
the lipophilic coating disposed on the first side of the optically transparent substrate and the second side of the optically transparent substrate.

4. The system of claim 1, comprising:
the lipophilic coating comprises at least one of flaxseed oil, lemon oil, walnut oil, olive oil, sesame oil, grapefruit oil, or a combination thereof.

5. The system of claim 1, comprising:
the lipophilic coating having a thickness in a range of 5 nm to 150 μm.

6. The system of claim 1, comprising:
the lipophilic coating is configured to reduce a thickness of the contaminant by 30% to 95%.

7. The system of claim 1, comprising:
the optically transparent substrate disposed in an ophthalmic frame.

8. The system of claim 1, comprising:
an anti-reflective coating disposed on the optically transparent substrate; and
the lipophilic coating disposed on the anti-reflective coating.

9. The system of claim 1, comprising:
the lipophilic coating comprises an oil.

10. The system of claim 1, comprising:
the lipophilic coating comprises a PFAS-free coating.

11. A method, comprising:
mixing an oil with a diluent to form a mixture;
disposing the mixture on an optically transparent substrate; and
curing the mixture to form a lipophilic coating on the optically transparent substrate, the lipophilic coating configured to disperse a contaminant disposed on the lipophilic coating such that the contaminant disposed on the lipophilic coating is optically transparent.

12. The method of claim 11, comprising:
curing the mixture with ultraviolet light.

13. The method of claim 11, comprising:
curing the mixture for a time in a range of 15 minutes to 48 hours.

14. The method of claim 11, comprising:
spraying the mixture on the optically transparent substrate.

15. The method of claim 11, wherein the oil comprises at least one of flaxseed oil, lemon oil, walnut oil, olive oil, sesame oil, grapefruit oil, or a combination thereof.

16. The method of claim 11, wherein the diluent comprises at least one of isopropyl alcohol, paint thinner, processed vegetable oil, or a combination thereof.

17. The method of claim 11, comprising:
disposing the mixture on a first side of the optically transparent substrate.

18. The method of claim 11, comprising:
disposing the mixture on a first side of the optically transparent substrate; and
disposing the mixture on a second side of the optically transparent substrate, the second side of the optically transparent substrate disposed opposite the first side of the optically transparent substrate.

19. The method of claim 11, comprising:
disposing the optically transparent substrate in an ophthalmic frame.

20. The method of claim 11, comprising:
disposing an anti-reflective coating on the optically transparent substrate; and
disposing the lipophilic coating on the anti-reflective coating.
